(19) United States
(12) Patent Application Publication
(10) Pub. No.: US 2018/0245615 A1
(43) Pub. Date: Aug. 30, 2018

(54) Connecting Assembly

(71) Applicants: Compagnie Plastic Omnium, Lyon (FR); Yanfeng Plastic Omnium Automotive Exterior Systems Co., Ltd., Shanghai (CN)

(72) Inventors: Chaodong Tan, Shanghai (CN); Xiaojun Zhu, Shanghai (CN); Jiangang Su, Shanghai (CN); Zhongyu Ma, Shanghai (CN)

(21) Appl. No.: 15/751,305

(22) PCT Filed: Aug. 15, 2016
(86) PCT No.: PCT/CN2016/095360

§ 371 Date: Feb. 8, 2018

(30) Foreign Application Priority Data
Aug. 17, 2015 (CN) 201510504449.6

(51) Int. Cl. F16B 5/06; B60R 3/00

(52) U.S. Cl. CPC F16B 5/0692; B60Y 2410/113; B60R 3/002

(57) ABSTRACT

The present invention provides a connecting assembly including a first member and a second member, the first member having at least one rectangular pierced structure, a cantilever snap extending along the Y direction from a bottom edge of the rectangular pierced structure, and a limiting rib extending along the X direction from the lateral edge of the rectangular pierced structure; the second member having a snap structure capable of cooperating in snap-fit with the cantilever snap in the Y direction, and a plurality of reinforcement ribs arranged above the snap structure and extending along the Z direction; wherein, the two most lateral reinforcement ribs among all reinforcement ribs of the second member are arranged at the inner side of the limiting ribs of the first member and spaced apart in parallel with the limiting rib with a first gap L1 in the X direction. According to the present invention, the limiting ribs of the first member limit the position of the reinforcement ribs of the second member so as to restrict the expansion or contraction of the second member in its longitudinal direction when heated or cooled, thereby the controlling of the matching of the connecting assembly is achieved.

### FIELD OF INVENTION

The present invention relates to the field of vehicle body part, and more particularly to a connection mechanism.

### BACKGROUND OF THE INVENTION

Vehicle body part, for instance a running board, which is referred to as side steps located at each lateral side of the vehicle body and under side doors, and sometimes can also be designed as exterior parts for stepping, usually is made of plastic material and to be assembled with peripherals to the sheet metal parts of the vehicle body.

Currently, there are two kinds of method to assemble the running boards: the first one relies on fixing the running boards directly onto the sheet metal parts of the vehicle body by using fasteners, which are mounted in Y direction (transversal direction of the vehicle) and Z direction (vertical direction of the vehicle), such design is typically used by General Motors or Shanghai Automotive Industry Corporation; the second one relies on assembling the running boards onto the sheet metal parts of the vehicle body through an inner panel, which is installed onto the metal sheet parts by fasteners, snaps or a conjunction of the two, and then the running boards are installed onto the inner panel by snapping or welding.

As for the running boards assembled by fasteners, the fasteners are pre-installed in the Doghouse of the running boards, and then installed onto the sheet metal parts. This mechanism complicates the mold structure since lifter or slider is required during the molding; at the same time, Doghouse structure is designed directly on the B surface (back surface) of the running boards, there is a big risk of producing a sink mark on the A surface (front surface), which in turn reduces the product qualification; finally, the assembly by using fasteners can only be disassembled in a destructive way. In terms of cost, for large dimension products, the one-time investment cost of using inner panels is generally lower than that of fasteners (cost efficiency depends on the planned dimension of products and costs for fasteners). Thus, in terms of synthesis, it's more advantageous to install the running boards through inner panels than fasteners.

There are also two kinds of method to connect a running board with a vehicle body through an inner panel, one of which is to connect the running board with the inner panel through welding. Such a design may result in the following three problems: 1) welding rib may rise the risk of producing a sink mark on the A surface, which in turn reduces the product qualification; 2) the running board welded to the inner panel can only be disassembled in a destructive way; and 3) the inner panel is welded onto an outer panel and then the inner panel and the outer panel as an assembly are installed onto the metal sheet parts of the vehicle body, which increases the gross weight and does not facilitate assembly.

Thus, the running boards are assembled to the inner panels more advantageous by snapping than welding. However, current running boards of the same structure have the defects that the running boards tend to deform when heated, and the assembly and disassembly force cannot be effectively controlled.

### SUMMARY OF THE INVENTION

The object of the present invention is to provide a connecting assembly for a vehicle body part, so as to solve the defects in the prior art that the vehicle body part tends to deform after being heated, and the assembly and disassembly force of the vehicle body part cannot be effectively controlled.

To solve this technical problem, the present invention adopts the following technical solutions:

According to a first aspect of the present invention, there is provided a connecting assembly comprising a first member and a second member, characterized in that the first member comprising: at least one pierced structure and a limiting rib extending along the X direction from a lateral edge of the pierced structure;

the second member comprising: a plurality of reinforcement ribs extending along the Z direction;

wherein, the two most lateral reinforcement ribs among all reinforcement ribs of the second member are arranged at the inner side of the limiting rib of the first member and spaced apart, preferentially in parallel, with the limiting rib with a first gap in the X direction.

In the context of the present invention, the terms of “the X, Y, and Z directions” are respectively defined as the longitudinal direction, the transversal direction, and the vertical direction of the vehicle. And the term of “the inner side” represents the region between a pair of limiting ribs in the X direction.

Such a delicate design of the present invention by cooperating the limiting ribs of the first member with the reinforcement ribs of the second member for position limitation renders it possible to effectively control the deformation of the second member when environmental temperatures change fiercely or in the event of other factors, which guarantees a holistic aesthetic appearance and more importantly, raises customer satisfaction.

In a preferred embodiment of the present invention, the first member further comprises a cantilever snap extending along the Y direction preferentially from a bottom edge of the pierced structure, and the second member further comprises a snap structure, capable of cooperating in snap-fit with the cantilever snap in the Y direction.

Advantageously, the reinforcement ribs are arranged above the snap structure. Advantageously, the first gap L1 is between 1.5 and 3 mm.

In a preferred embodiment of the present invention, the reinforcement rib of the second member has a width extending along the X direction, and the second member has a thickness extending along the Y direction. As verified through repeated experiments by the inventor, when the width of the reinforcement rib is preferably less than one third of the thickness of the second member, it can be effectively ensured that the main body of the second member does not produce a sink mark on the backside of the reinforcement rib.

According to a second aspect of the present invention, there is also provided another connecting assembly comprising a first member and a second member, the first member comprising a limiting rib extending along the X direction, the second member being provided with a spacing structure in the Z direction, characterized in that the spacing structure comprises an upper spacing element and a lower spacing element, spaced apart and oppositely arranged in the Z direction each other, and that the limiting rib of the first member is fitted between the upper spacing element and the lower spacing element.

In this connecting assembly, the spacing elements in the Z direction of the second member cooperate with the limiting rib of the first member to provide another supporting structure in the Z direction in addition to the snap-fit structure, and therefore provide an extremely firm connecting assembly. Moreover, the disassembly force of the connecting assembly can be further adjusted by adjusting the extending length in the Y direction of the spacing element 13 (Z direction) or the gap in the Z direction between the spacing element and the limiting rib.

Preferably, the second gap L2 in the Z direction between the upper spacing element and the limiting rib is between 0.3 and 0.8 mm, and the third gap L3 in the Z direction between the lower spacing element and the limiting rib is between 0.1 and 0.3 mm.

Preferably, the second gap L2 is around 0.5 mm, and the third gap L3 is around 0.2 mm.

In a preferred embodiment of the present invention, the first member further comprises a cantilever snap extending along the Y direction, and the second member further comprises a snap structure, capable of cooperating in snap-fit with the cantilever snap in the Y direction.

The first member is further provided with a limiting boss extending along the Y direction.

The connecting assembly provided by the present invention has prominent advantages over the prior art, including: 1) realizing the overall control of the matching between the second member and the first member benefiting from the limiting effect of the limiting ribs of the first member to the reinforcement ribs of the second member, even though the latter presents a thermal expansion in the longitudinal direction; 2) adjustable assembly and disassembly force is achieved by setting the spacing structure in the Z direction on the second member, the assembly and disassembly force of the connecting assembly can be adjusted according to the requirements of different products by modifying the size of the gaps between the limiting ribs and the spacing elements in the Z direction.

### BRIEF DESCRIPTION OF THE DRAWINGS

FIG. 1 is a structural schematic view of a first member according to a preferred embodiment of the present invention;

FIG. 2 is a structural schematic view of a second member according to a preferred embodiment of the present invention;

FIG. 3 is a structural schematic view of the first member as shown in FIG. 1 assembled with the second member as shown in FIG. 2;

FIG. 4 is a cross-sectional view taken along the line B-B of FIG. 3;

FIG. 5 is a cross-sectional view taken along the line C-C of FIG. 3; and

FIG. 6 is a cross-sectional view taken along the line D-D of FIG. 3.

### DETAILED DESCRIPTION OF THE INVENTION

The preferred embodiments of the present invention will be provided and described in detail with reference to the drawings so as to facilitate the understanding of the functions and features of the present invention.

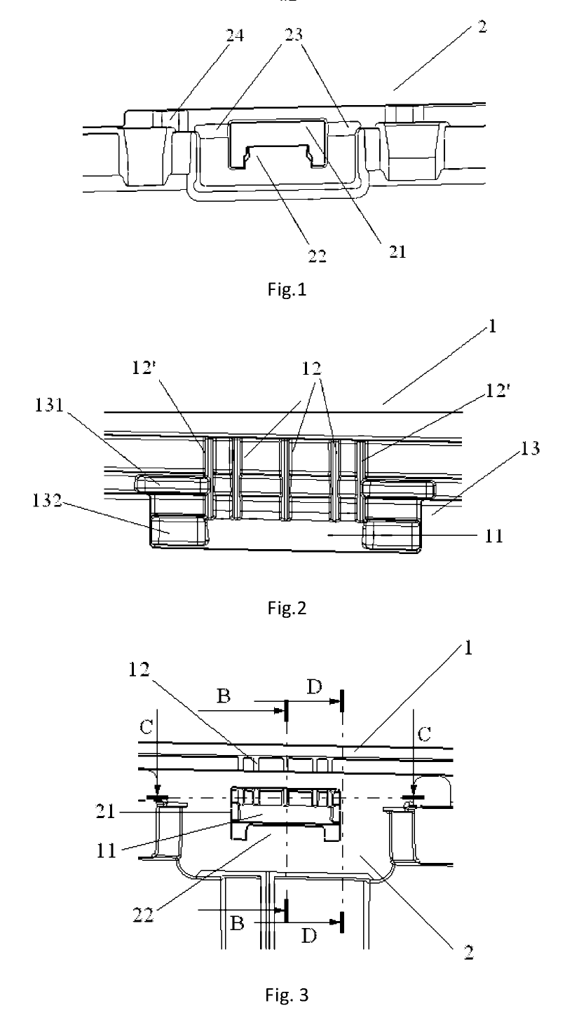

The present invention provides a connecting assembly for a vehicle body part, and more particularly in this embodiment a vehicle running board assembly, comprising a running board 1 (the second member) and an inner panel 2 (the first member), the running board 1 is installed to the sheet metal parts of the vehicle body through the inner panel 2, wherein the structures of the running board 1 and the inner panel 2 are shown in FIGS. 1 and 2 respectively. It could be understood that other examples of such a connecting assembly of another vehicle body part also fall into the protection scope of the present invention.

The inner panel 2 comprises: at least one rectangular pierced structure 21, a cantilever snap 22 extending from the bottom edge of the rectangular pierced structure 21 along the Y direction, and a limiting rib 23 extending from the lateral edge of the rectangular pierced structure 21 along the X direction. Correspondingly, the running board 1 comprises: a snap structure 11 capable of cooperating in snap-fit with the cantilever snap in the Y direction, and a plurality of reinforcement ribs 12 arranged above the snap structure 11 and extending along the Z direction, which are five as shown in the drawing.

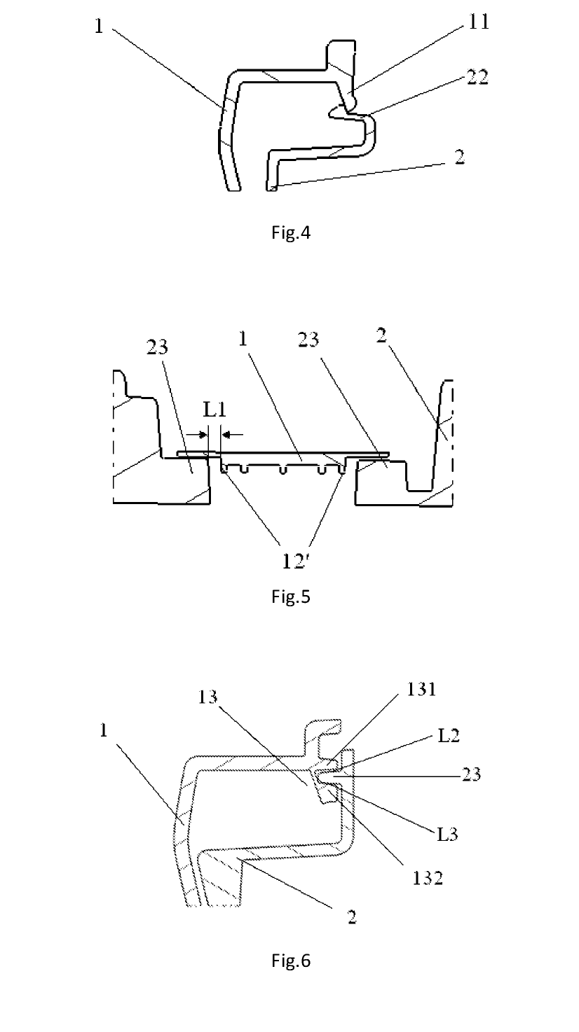

In the process of assembly, the snap structure 11 of the running board 1 presses down the cantilever snap 22 of the inner panel 2 and makes it deformed, and the running board 1 moves on forward until it abuts against the inner panel 2 to achieve the assembly, as shown in FIGS. 3 and 4. At this time, the reinforcement ribs 12 of the running board 1 are completely arranged in the inner side of the rectangular pierced structure 21 of the inner panel 2 and meanwhile in the inner side of the limiting ribs 23, and the two most lateral reinforcement ribs 12′ are respectively arranged in parallel with the limiting ribs 23 with a first gap L1 in the X direction, as shown in FIG. 5.

It is well-known that the running board 1 is about 2 m in length in the X direction and tends to expand when heated. The running board will expand about 7 mm at the temperature of 85° C., i.e., the running board 1 will expand about 3.5 mm towards each side by taking the central point as a reference point, and such a deformation from the reference point to each side will gradually increase. Since the running board includes more than one pair of mutually cooperated cantilever snap 22 and snap structure 11, which may be three pairs, four pairs or five pairs, the deformation of the running board can be effectively controlled by a plurality of limiting ribs. Thus, preferably, the first gap L1 is between 1.5 and 3 mm.

According to a preferred embodiment of the present invention, the number of the reinforcement ribs 12 of the running board 1 is not limited to five. Normally, the running board is designed to have three reinforcement ribs, the number of which will later be adjusted according to the actual strength thereof and the state when assembled into the vehicle, that is to say, the number of the reinforcement ribs can be adjusted according to actual conditions.

The reinforcement rib 12 of the running board 1 has a width extending along the X direction, and the running board 1 has a thickness extending along the Y direction. In order to prevent a sink mark on A surface of the running board 1, the width of the reinforcement rib 12 is preferably less than one third of the thickness of the running board 1. According to experience, the width of the reinforcement rib is preferably designed to be 0.8 mm.

According to a further preferred embodiment of the present invention, the running board 1 is also provided with a spacing structure 13 in the Z direction at the outer side of the most lateral reinforcement rib 12′, here “outer side” means the region which is not included in the region being arranged with a set of reinforcement ribs 12. The spacing structure 13 in the Z direction comprises an upper spacing element 131 and a lower spacing element 132 that are spaced apart and oppositely arranged in the Z direction. When the running board 1 is assembled with the inner panel 2, the limiting rib 23 of the inner panel 2 is just embedded in the spacing structure 13 in the Z direction, as shown in FIG. 6.

The second gap L2 in the Z direction between the upper spacing element 131 and the limiting rib 23 is preferably between 0.3 and 0.8 mm, and the third gap L3 in the Z direction between the lower spacing element 132 and the limiting rib 23 is preferably between 0.1 and 0.3 mm.

The second gap L2 is more preferably around 0.5 mm, and the third gap L3 is more preferably around 0.2 mm.

According to a yet preferable embodiment of the present invention, the force used to disassemble the running board assembly can be adjusted by adjusting the extending length in the Y direction of the spacing structure 13 in the Z direction or the sizes of the second gap L2 and the third gap L3. The running board is disassembled through rotation and recession. In the process of disassembly, the disassembly force will be affected by both the extending length in the Y direction of the spacing structure 13 in the Z direction and the size of the gap between the spacing structure 13 in the Z direction and the limiting rib 23 of the inner panel 2. For instance, the longer the spacing structure 13 in the Z direction is in the Y direction, the greater support in the Z direction during rotation, and the bigger the disassembly force; and the smaller the gap between the spacing structure 13 in the Z direction and the limiting rib 23, the greater the overlapping area between the spacing structure 13 in the Z direction and the limiting rib 23 during the rotation, and the bigger the disassembly force. Hence, the disassembly force required for the running board can be adjusted through adjusting the above parameters so as to meet the requirements of different customers.

Preferably, the inner panel 2 is also provided with a limiting boss 24 extending in the Y direction for the sake of position limitation when the running board 1 is assembled onto the inner panel 2.

According to the present invention, the inner panel 2 can be installed to the sheet metal parts of the vehicle body by fasteners, snaps or the combination of fasteners and snaps.

The above is only the preferred embodiments of the present invention and is not intended to limit the scope of the present invention. Variations can be also be made to the embodiments of the present utility model, that is, any simple and equivalent variations and modifications made according to the claims and description of the present application for invention fall into the protection scope defined in the claims of the present invention. Those that are not described in detail herein are customary technical content.

1. A connecting assembly comprising a first member and a second member, the first member comprising:
at least one pierced structure and a limiting rib extending along an X direction from a lateral edge of the pierced structure;
the second member comprising: a plurality of reinforcement ribs extending along a Z direction;
wherein, the two most lateral reinforcement ribs among all reinforcement ribs of the second member are arranged at an inner side of the limiting rib of the first member and spaced apart from the limiting rib with a first gap in the X direction.

2. The connecting assembly according to claim 1, wherein the first member further comprises a cantilever snap extending along a Y direction, and the second member further comprises a snap structure, capable of cooperating in snap-fit with the cantilever snap in the Y direction.

3. The connecting assembly according to claim 2, wherein the reinforcement ribs are arranged above the snap structure.

4. The connecting assembly according to claim 1, wherein the first gap is between 1.5 and 3 mm.

5. The connecting assembly according to claim 1, wherein the reinforcement rib of the second member has a width extending along the X direction, the second member has a thickness extending along a Y direction, and a width of the reinforcement rib is less than one third of the thickness of the second member.

6. A connecting assembly comprising a first member and a second member, the first member comprising a limiting rib extending along an X direction, the second member being provided with a spacing structure in a Z direction, such that the spacing structure comprises an upper spacing element and a lower spacing element, spaced apart and oppositely arranged in the Z direction relative to each other, and that the limiting rib of the first member is fitted between the upper spacing element and the lower spacing element.

7. The connecting assembly according to claim 6, wherein a second gap, being arranged in the Z direction between the upper spacing element and the limiting rib is between 0.3 and 0.8 mm, and a third gap, being arranged in the Z direction between the lower spacing element and the limiting rib is between 0.1 and 0.3 mm.

8. The connecting assembly according to claim 7, wherein the second gap is around 0.5 mm, and the third gap is around 0.2 mm.

9. The connecting assembly according to claim 6, wherein the first member further comprises a cantilever snap extending along the Y direction, and the second member further comprises a snap structure, capable of cooperating in snap-fit with the cantilever snap in the Y direction.

10. The connecting assembly according to claim 1 wherein the first member is further provided with a limiting boss extending along the Y direction.

11. The connecting assembly according to claim 6 wherein the first member is further provided with a limiting boss extending along the Y direction.

12. The assembly according to claim 1 wherein the two most lateral reinforcement ribs are parallel to the limiting rib.

13. The connecting assembly according to claim 7, wherein the first member further comprises a cantilever snap extending along the Y direction, and the second member further comprises a snap structure, capable of cooperating in snap-fit with the cantilever snap in the Y direction.

14. The connecting assembly according to claim 8, wherein the first member further comprises a cantilever snap extending along the Y direction, and the second member further comprises a snap structure, capable of cooperating in snap-fit with the cantilever snap in the Y direction.

15. the connecting assembly of claim 2 wherein the cantilever snap extends from a bottom edge of the pierced structure.

16. The connecting assembly according to claim 7, wherein the second gap is around 0.5 mm.

17. The connecting assembly according to claim 7, wherein the third gap is around 0.2 mm.
